(19) United States
(12) Patent Application Publication
(10) Pub. No.: US 2014/0213181 A1
(43) Pub. Date: Jul. 31, 2014

(54) Linking Manager

(71) Applicant: Einar Rosenberg, Miami, FL (US)

(72) Inventor: Einar Rosenberg, Miami, FL (US)

(21) Appl. No.: 14/177,104

(22) Filed: Feb. 10, 2014

Related U.S. Application Data
(63) Continuation-in-part of application No. 14/167,974, filed on Jan. 29, 2014.
(60) Provisional application No. 61/762,952, filed on Feb. 10, 2013.
(60) Provisional application No. 61/758,269, filed on Jan. 29, 2013.

(51) Int. Cl. H04B 5/00; H04W 76/02

(52) U.S. Cl. CPC H04B 5/0056; H04W 76/023
USPC 455/41.1

(57) ABSTRACT

A system and method is provided for electronically establishing communications between a third device and a second device whereby a first device communicates with the second device and then the third device to provide access for the third device information to the second device. The first device receives linking information from said second device and provides that information to the third device. The first device may also create a rule regarding the communication between the second and third device and provide that rule to the third device for incorporation.

### CROSS REFERENCE TO RELATED APPLICATION

This application claims the benefit of U.S. provisional patent application No. 61/762,952, filed Feb. 10, 2013, the disclosure of which is incorporated herein by reference in its entirety; this application is also a continuation-in-part application of and claims the benefit of U.S. patent application No. 14/167,974, filed on Jan. 29, 2014, which claims the benefit of U.S. provisional patent application No. 61/758,269, filed Jan. 29, 2013, the disclosures of which are incorporated herein by reference in its entirety.

### BACKGROUND OF THE INVENTION

Today's marketplace provides many near field communication (“NFC”) devices. Currently, the predominant number of NFC devices are computers and computer systems used in Point of sale (“POS”) application. There has been a recent, significant increase in the number of NFC mobile communication devices, e.g., a NFC Smartphone. Manufacturers are also now beginning to include NFC in other electronic devices, such as stereos and televisions.

NFC has many positive characteristics including the characteristic which enables two NFC devices to be connected together. Once a NFC device is paired with, i.e., established communications with, a second NFC device, the devices can be linked, i.e., the second NFC device can access and use a resource of the first NFC device. For example, a NFC mobile communication device can pair with a NFC Stereo to link streaming music from the mobile communication device to the stereo (or vice versa). In another approach, a NFC Tablet can pair with an NFC enabled Wi-Fi Router to link it to give the Tablet internet access.

There are many devices today that NFC can be used to link both NFC enabled devices via any one of a number of secondary communication links such as Wi-Fi, Bluetooth, Wireless USB, Ethernet, Cellular, and more. This creates simplicity of linking devices and increases security of pairing, except for one key security issue. Due to the inherent characteristics of an NFC system, almost anyone with an NFC device can link to any other NFC device. But there are times and situations that it would be desirable to control who has access to a device. For example, in the situation of a home Wi-Fi network where it is relatively easy to have devices link to the Wi-Fi network. However, it is preferably that access to the Wi-Fi network be controllable. It is convenient and easy to be able to link one's devices and/or even friends' and associates devices to the Wi-Fi network, but it is preferable that not everyone who comes into your house should be able to connect to the Wi-Fi network. For example, a repairman, e.g., a plumber, who came to fix the sink or the date of one of your party guests you've never met, should not necessarily have unrestricted access to the Wi-Fi network, e.g., by simply touching and therefore linking their NFC mobile communication device with the Wi-Fi network and being an accepted device in your network.

Additionally, in a situation where a friend has been provided a password and given access to an electronic device, the friend can then provide the password to someone else without limitations, e.g., the friend can then turn around and provide the password to an unknown or an undesirable person. In yet another situation, a friend is provided with a password for them to connect a first device, e.g., their computer, and instead they use the password to connect multiple devices, e.g., laptop, tablet, and mobile communication device. Or that party guest can easily find your router and press the WPS button, thereby broadcasting instant Wi-Fi access to any WPS capable device.

Therefore, it would desirable to provide controlled wireless access by a third party to another electronic device.

### BRIEF DESCRIPTION OF THE DRAWINGS

FIG. 1 shows a method of using an administrator NFC Device to link one or more additional NFC Devices to a core access NFC device where the administrator is allowing either transmission and/or receiving capabilities.

FIG. 1 depicts an exemplary overview of the invention;

FIGS. 2 (a)-(d) depict an exemplary application of the invention where an administrator device links a non-administrator device to a core device;

FIG. 3 depicts a flow chart showing an exemplary process flow of the invention depicted in FIGS. 1 and 2(a)-(d);

FIGS. 4 (a)-(d) depict another exemplary application of the invention where an administrator device links a non-administrator device to a core device; and

FIGS. 5 (a)-(c) depict yet another exemplary application of the invention where an administrator device links a non-administrator device to a core device.

### DETAILED DESCRIPTION OF THE INVENTION

In the following detailed description, reference is made to the accompanying drawings, which form a part hereof, and in which is shown by way of illustration specific exemplary embodiments of the invention. These embodiments are described in sufficient detail to enable those of ordinary skill in the art to make and use the invention, and it is to be understood that structural, logical, or other changes may be made to the specific embodiments disclosed without departing from the spirit and scope of the present invention.

The invention discloses a method of using an first electronic device which administers wireless access by a third electronic device to a second electronic device.

More specifically, the invention provides a method for controlled wireless access by a third device to a second device, and in certain aspects a first device. The first device provides to at least one of the second and third devices: management rules, restrictions, credentials, instructions, and other forms of managing and providing wireless communications between the second and third devices.

The invention, a “Linking manager” has at least two significant features: The ability to use an administrator device which is mobile and relatively always with a user which enables providing, relatively quickly and easily, the ability to communicate to a visiting device, access instructions and credentials to communicate with a core device that the administrator device administers. It additionally provides the ability for the an administrator device to establish rules and restrictions onto the visiting device, for example, as how and for how long the visiting device can communicate with the core device.

In exemplary approach, an Administrator Device—a first device—having close proximity communication functionality, e.g., an Administrator NFC mobile communication device, controls wireless access by a third device to a second device which may or may not be NFC enabled. The second device may also be referred to as a core device or core access device. The core device can generally use a variety of communication technologies such as Bluetooth, Wi-Fi, Cellular, Wireless USB, Ethernet, etc., to link and communicate with a third device. The administrator NFC Device provides a third device controlled access to link and allow communications between the third device and the core access device. The administrator device contains linking information, e.g., credentials, for access to the core device. As discussed more fully below, controlled access includes parameters for controlling different aspects of the third devices' communication with the second device.

The linking information is stored on the administrator device either manually or automatically. Manual storage requires a user or a third person to manually enter and store linking information on the administrator device. Automatic storage requires an administrator device communicating with a core device and as part of the communications the administrator device receives linking information from the core device and the administrator device stores the linking information on the administrator device. The linking information resides on the administrator device as a result of the linking information being either previously stored in administrator device or the information can be stored on the administrator device substantially contemporaneously with the process of providing a third device controlled access to a core device.

For example, when a user first purchases a core device, e.g., a smart TV, and installs it in their home, the user sets up the administrator credentials, e.g., linking information, and in an aspect access management rules are also set up, either by inputting them manually or the information can be communicated electronically to the administrator device on that day. That information is then stored on the administrator device. At a subsequent time, e.g., days, weeks, or months later, the user receives a guest who wishes to electronically link, most likely wirelessly, his electronic device to the core device, e.g., the TV. As the user has previously setup the credentials and management rules for linking to the core device, the information is already stored in the administrator device. Electronic methods of receiving that information at the date of initial setup of linking manager of managing access to the TV via the manager device can be received by the manager device via NFC reading of a tag in the installation package that came with the TV, or the TV can have other communication methods such as NFC, Bluetooth, Wi-Fi, or 2D barcode. In another aspect, the information can be input on a PC computer and then emailed or otherwise sent electronically to the administrator device.

In an exemplary approach, linking information is the information necessary for one device to electronically connect to another device. The form and content of linking information is dependant context. For example, in many situations, linking information is a password necessary for a device to gain access to another device, network, etc. In other situations, the linking information includes identification of the other device, network, etc., and a password. In yet other situations, linking information contains information to access another device, network, etc., and is a combination of identification information, password, and other information.

In a preferred approach, linking and management rules information is supplied to the administrator device prior to providing any information to a third device seeking access to the second device. Linking and rules information can be communicated in many ways to the administrator device and although preferably, that information does not have to be communicated via close proximity. In a preferred approach, when time appropriate the administrator mobile communication device uses close proximity communication to communicate to the third device the credentials and management rules for communicating with the first device. In an aspect, if a second device has NFC capabilities, the administrator device accesses linking information, e.g., communication access information, via NFC to NFC device communication. Once the Administrator NFC device has the linking information for the core device, the administrator device uses close proximity communications, e.g., NFC to NFC device communication, to administer access to the third NFC device(s). In an aspect, the administrator NFC device uses either management rules provided to the third device and/or secondary communication method to control access to the core access device(s) or the third NFC Device(s).

Management rules include, for example but are not limited to, transmission and receiving restrictions, timers (e.g., a time period), applications to monitor access, applications to track usage, and other security, restriction, and monitoring methods to control access to the core access device(s). Management rules allow (or disallow) for closed communication, access control of core access devices, and private or hidden information transmission of linking information. Management rules can be removed or modified at any time by the administrator's NFC mobile communication device 10 communicating to either the core device 65 or the third device 15 via NFC or a secondary communication method. For example, a management rule regarding transmission and receiving restrictions indicates that non-administrator device 15 can only communicate with the core device 65 using Wi-Fi communications. For example, a management rule regarding timers indicates that non-administrator device 15 can only communicate with the core device 65 until 4 p.m. today.

The management rules received by the non-administrator device 15 are processed by its use control program, e.g., which incorporates the rule into its operation, which follows the rules as instructions controlling its actions. Thus, if a rule indicates that the non-administrator device 15 can only communicate with the core device 65 until 4 p.m. today, then the use control program does not enable the non-administrator device 15 to communicate with core device 65 after 4 p.m. today, unless another rule has been received by the non-administrator device 15 which indicates to the contrary. In another example, if a rule indicates that non-administrator device 15 can only communicate with the core device 65 using Bluetooth communications, then the use control program enables the non-administrator device 15 to only communicate with core device using Bluetooth communications, unless another rule has been received by the non-administrator device 15 which indicates to the contrary.

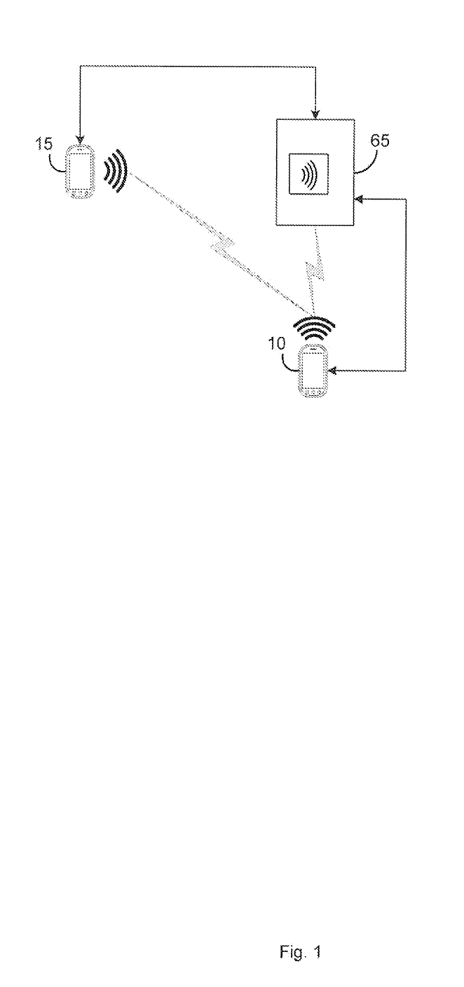

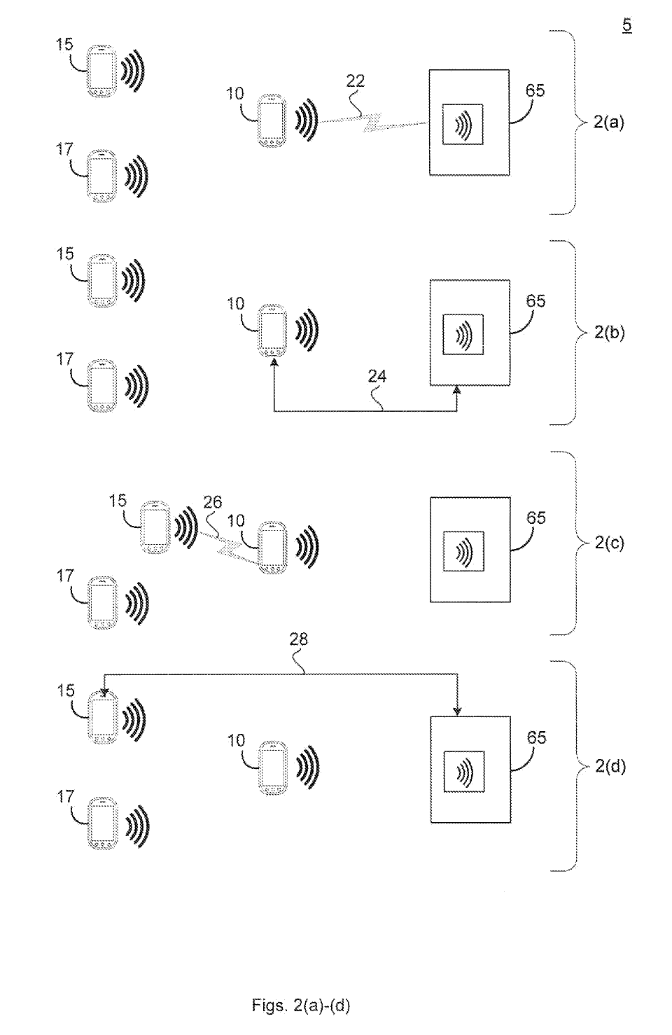

FIG. 1 depicts a system 5 according to an exemplary embodiment of the invention. The system 5 includes a device 65, a close proximity, e.g., NFC, mobile communication device 10 and a second a close proximity, e.g., NFC, mobile communication device 15. The device 65 is a “core” electronic device, e.g. a stereo, TV, router, etc., that includes some communications abilities, preferably, at least a close proximity communication, e.g., NFC, and a second form of communications, e.g., Bluetooth. In a preferred approach, the core device 65 has intelligence, e.g., is a Smart TV.

In another aspect, the core device 65 is not an intelligent device, e.g., not a Smart TV, but is an electronic device with several capabilities, including the ability to link electronically with another device, e.g., a mobile communication device; and in an aspect, provide the linking information to the device 10 that the device can provide to other devices. For example, the core device is a non-smart TV that is able to show photos, play music, and/or show videos. The administrator device 10 that is aware that the core device 65 is a non smart TV can define, as part of the rules, to the visitor device 15 the capabilities of the core device 65. The administrator device 10 can define to the visitor device 15 which capabilities the visitor device 15 does or does not have access to on that TV 65. As such, the management rules, for example, indicate to the visitor device that when linking with the non-smart TV 65, that the visitor device 15 can only send photos or videos but not music files to the device 65.

Close proximity mobile communication devices, e.g., NFC enabled mobile communication devices, 10 and 15 are, for example, smart phones, capable of at least NFC communications. The NFC mobile communication devices 10, 15 also include typical smart phone capabilities, including Wi-Fi, Bluetooth, SMS, access to public communications networks, and access to the world web wide. Mobile communication devices have inherent abilities, e.g., NFC capabilities, the ability to navigate the Internet, and make cellular phone calls. Mobile communication devices also can download, install, and execute programs—apps—that interact with other programs and capabilities of the mobile communication device. Thus, exemplary descriptions of the invention may refer to a mobile communication device performing a certain feature. However, it may be a situation where it is more specifically a program running on the mobile communication device that causes the mobile communication device to perform certain actions.

In an aspect, the mobile communication device 10 is preferably running an appropriate program, e.g., an “administrator control” program for the context of the device and the context of use. An appropriate program effectuates administration of wireless access to another device, e.g., a core device 65. In an approach, a user selects the appropriate program to run on the mobile communication device 10. In another approach, the user touches his mobile communication device 10 to the core device 65 to initiate NFC communications using the inherent NFC capability of the mobile communication device 10. As part of the initial communications, the mobile communication device 10 receives data from the core device 65. Part of the data received from the NFC device 65 indicates an appropriate program to be running on the mobile communication device 10. Preferably, the mobile communication device's 10 operating system looks for the appropriate program on the mobile communication device 10, and if it isn't already executing, then using another part of the data received from the NFC core device 65, the operating system determines where to download the appropriate program from and causes the program to be downloaded, installed and executed on the mobile communication device 10. The appropriate program on the mobile communication device 10 uses part of the data received from the core device 65 to determine what to do. For example, the appropriate program causes the mobile communication device 10 to perform some action, e.g., to get input from the user. In a context, an “administrator control” program—app—is an appropriate program to be executed on an administrator mobile communication device, e.g., mobile communication device 10.

The administrator control program has administrative capabilities. For example, the administrator mobile communication device 10 received communication access information to the core device 65, e.g., a password to access the device 65. Furthermore the administrator mobile communication device 10 can provide the password of the core device 65 to other mobile communication devices, e.g., device 15, or other devices. Additionally, the administrator mobile communication device can create, modify, and update management rules for the other mobile communication devices and other devices for accessing and interacting with the core device.

In an aspect, the mobile communication device 15 is preferably running an appropriate program for the context of the device and the context of use. An appropriate program effectuates wireless access to another device, e.g., a core device. In an approach, a user selects the appropriate program to run on the mobile communication device 15. In another approach, the user touches the mobile communication device 10 to initiate NFC communications using the inherent NFC capability of the mobile communication device 15. As part of the initial communications, the mobile communication device 15 receives data from the mobile communication device 10. Part of the data received from the NFC device mobile communication device 10 indicates an appropriate program to be running on the mobile communication device 15. Preferably, the mobile communication device's 15 operating system looks for the appropriate program on the mobile communication device 15, and if it isn't already executing, then using another part of the data received from the mobile communication device 10, the operating system determines where to download the appropriate program from and causes the program to be downloaded, installed and executed on the mobile communication device 15. The appropriate program on the mobile communication device 15 uses part of the data received from the mobile communication device 10 to determine what to do. For example, the appropriate program causes the mobile communication device 15 to perform some action, e.g., to get input from the user.

The “use control” program is an appropriate program to be run on the non-administrator mobile communication device 15 and other devices for communicating with the administrator mobile communication device and receiving information from the administrator mobile communication device. The received information includes, for example, linking information for access to the core device and the receipt of management rules. The use control program uses the linking information to access the core device. The linking information includes, for example, a password for access to the core device and an indication of the preferred communication method, as well as possible other communication methods, for communicating with the core device. The use control program also executes and abides by the management rules received from the administrator mobile communication device.

In a preferred approach, the core device 65 includes an ability to perform an administrative pairing (e.g., communicate with) with an NFC device. When a device pairs with the core device 65, for example, NFC mobile communication device 10 pairs with core device 65, device 65 retains identifying information of the paired device as is conventionally done. Preferably, this first pairing occurs using NFC communications between device 10 and device 65. This first pairing results in the device 10 becoming the Administrator NFC device for the device 65. In an aspect, how long NFC mobile communication device 10 remains as the designated administrator for core device 65, as well as other features, depends on the management rules implemented on core device 65.

In an aspect where a core device includes a linking program, the program on the core device 65 includes management rules for various aspects of the breadth and scope of the relationship with the administrator device 10 and use devices. For example, one of the management rules relates to a determination and designation of an Administrator device. In an aspect the management rules indicate that the administrator device 10 is determined on a “first-come, first-served” approach: the first NFC mobile communication device to pair with the device 65 holds the privilege as and no other device can administrator pair with the device 65, unless and until the first NFC mobile communication device is no longer the administrator pair. In another approach, it is a last-come, first served approach: the last NFC mobile communication device to administrative pair with the device 65 holds that privilege and another device can subsequently administrative pair with the device 65 and bump the prior NFC mobile communication device from being administrative pair. Other reasonable management rules that disclose approaches and variations of designating the administrator device are also permitted for operation of the invention. Device 65 is also capable of receiving management rules from the administrator NFC device for controlling access by other devices to the core device. These management rules are similar to those describe above with respect to the use control program.

When the first NFC device 10 becomes the administrative pair with the NFC device 65 the first NFC device 10 is provided with certain administrative abilities with respect to device 65, thus becomes the administrator device for device 65. The creation of the administrator pair may also have other effects. For example, after the administrative pair is established, the core device 65 only provides linking information (e.g., password information and/or communication method information) to the administrator device 10. Thus, a user of another NFC cannot access linking information from the core device 65. Furthermore, when an administrator device, e.g., mobile communication device 10, sends access information to another electronic device, e.g., mobile communication device 15, the access information is hidden or encrypted so that a user of the non-administrator NFC device cannot read and/or forward the access information to a fourth party. In an aspect, the user control program executing on the mobile communication device 15 limits or denies access to or forwarding of access information.

After the non-administrator NFC device 15 receives linking information from the administrator NFC device 10, device 15 can attempt to access core device 65 through a preferred communication method and using a password to have access to and/or receive information from device 65.

Although currently identified as a non-administrator NFC device, device 15 could have previously been or could be at a future time be an administrator NFC device to device 65 (and/or another core device). Although currently identified as an administrator NFC device, device 10 could have previously been or could at a future time be a non-administrator NFC device to device 65 (and/or another core device).

In an aspect, administrator NFC mobile communication device 10 implements a management rule to only allow mobile communication device 15 to receive information from core device 65, but mobile communication device 15 cannot send information to core device 65. Management rules can run in mobile communication device 15 and/or administrator mobile communication device 10 can use NFC and/or a secondary communication method to communicate to core device 65 to remove or modify access for mobile communication device 15.

To expand further, in an exemplary approach device 10 can communicate with device 65 at a first step to establish becoming the administrator. This communication can be done via NFC using NFC to NFC device communication. It can also be done using NFC as an initiator to establish a connection link between device 10 and device 65, where after using NFC to initiate, a second communication method or system is used. Such second communication can including Wi-Fi, Bluetooth, Wireless USB, or more long range communication methods such as cellular internet, where it can communicate directly to device 65, routed to its unique IP address, or using a router as a gateway. The information exchange for linking and access can include multiple security options including but not limited to passwords, public/private key, secure tokens, and more. It can also contain secure qualification methods, such as the device has to meet certain criteria to be qualified to communicate. For example, if there is a high level of secure encryption, the device might require a certain minimum of processing power to handle the encryption algorithm processing.

The linking information to communicate to device 65 can include instructions, and required levels of a communication standard. For example, device 10 can instruct device 15 that to communicate with device 65, it can do so using Wi-Fi, but device 15 must use WPA2 encryption. This would be a qualification, but also if device 15 qualifies, it must be instructed to use WPA2. Another example is that device 15 must use Bluetooth, but requires the device to turn off its visibility and if the device is connected to another Bluetooth device, it must remove the link to the other Bluetooth device if it wishes to communicate with device 65. In that example, today, Bluetooth can pair with more than one device at a time. You can have a Bluetooth connection, simultaneously with more than one device. A user is able to have their phone streaming music to their car stereo, while at the same time talking on their Bluetooth headset. An instruction can include a modification of settings. So device 10 may receive or define any combination from both devices, as to the security credentials, the communication method, the communication technology, the handshake procedures, device communication qualifications, communication instructions, and management rules.

Additionally, devices 10, 15, and 65, are using common standards for communication, which allows them into a communication channel, or within a communication method, but at the gate, or with limited access in. For example, if the devices are using Wi-Fi, all three devices have Wi-Fi, and if the devices are made visible, then all the devices can see each other in the network. A simple example in Wi-Fi is that a laptop can scan and see all the different Wi-Fi networks near it. While it can see all the networks, it cannot have full access to any of the specific networks, but there is a basic level of communication to ask for basic information such as an SSID, or send a request to give a router a password to be reviewed to confirm access.

As a result, the invention is designed to conform to current standards of traditional communication methods, but gives a device management control and simplified distribution for a third device to get access to a first device. Using management rules, the second device can dynamically create, or previously have created, rules which manage, control, and/or define the third device's access to the first device. In an aspect, the management rules are designed to increase the security of communication between the first device and the third device.

As the average person is not technically proficient, and thus would benefit from a simple and intuitive method for management of access to their device, and management rule for those devices. The method of using NFC to transfer effectuate the running of appropriate programs and transfer of information, using NFC's touch paradigm, gives that intuitive ability for a person to define the users they wish to give access to the users core devices. With the increased number of electronic devices in a user's house, especially Smart Devices increases the importance of a user having the ability to control access by third parties to those devices.

If we are to give more and more devices access to each other, within a near or semi near proximity, we need easier methods of issuing, quickly and intelligently, access and management rules for those devices. The average person does not have a security department to monitor its networks, issue out badges, and revoke privileges. Yet the average user will soon have more internet and network connected devices in their house, then the average office. Even toys are now linking to the internet or to other network connected devices such as a television. To allow the average user to easily, and most importantly, intuitively issue and control access, the invention creates at least this benefit.

Although descriptions of exemplary embodiments include the use of NFC, the invention is not so limited. Other communication technologies such as Bluetooth, 2D Barcode scanning, audible transmission, and other such wireless communication methods can be used to accomplish management communication between the devices, e.g., from the third device to the first and/or second device. Furthermore, although the exemplary description refers to a single first device, single second device, and single third device, the invention is not so limited and the spirit of the invention can employ multiple first devices and/or multiple second devices and/or multiple third devices.

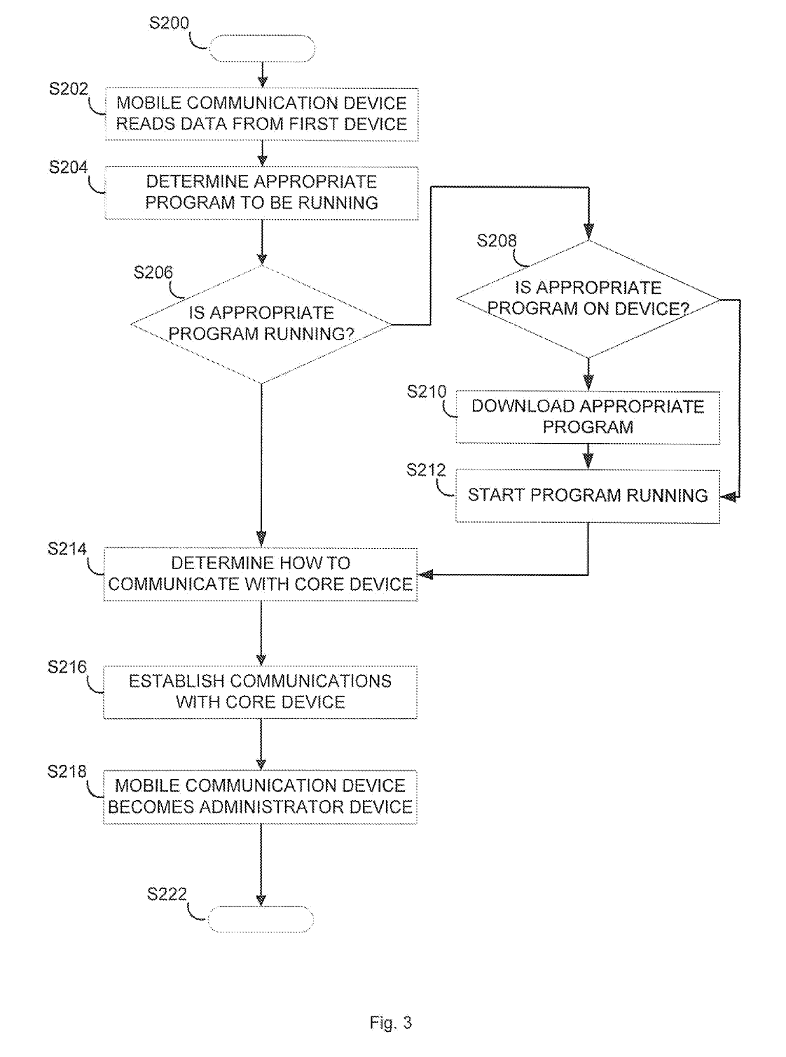

FIGS. 2 (a)-(d) depict an exemplary application of system 5 (FIG. 1) where a mobile communication device becomes an administrator device and links a non-administrator device to a core device.

In FIG. 2 (a), an NFC enabled mobile communication device 10 is placed in close proximity to an NFC enabled core device 65 and establishes communications 22 with the core device 65. Preferably, the communications between the mobile communications device 10 and the core device 65 are near field communications. If the mobile communications device 10 does not have the appropriate program executing on it, then the mobile communications device 10 uses data received as part of the communications with the core device to locate and download the appropriate program, e.g., an administrator program, and executes the program. As part of the communications received from the cored device 65, the mobile communications device 10 receives communication system information to access the core device 65 through NFC and/or a secondary communication system, e.g., Bluetooth, Wi-Fi, LAN, Internet, or otherwise.

In a preferred approach, the first channel is a close proximity communication technology which has an inherent benefit of creating increased security when transmitting credentials and management rules from the administrator device to the third device due to the physical arrangement, i.e., the closeness, that the devices must be to each other. In addition, the first channel being close proximity communication technology creates a ‘simply touch’ or ‘be near’ opportunity to more easily define which device is the device you wish to give credentials and management rules to.

In a preferred approach, the second communication channel is a non-close proximity communication technology, e.g., such as Wi-Fi, which has a range of around one hundred meters, or Bluetooth, which has a range of around ten meters, as opposed to using close proximity communication technologies such as NFC which has a range of around a few centimeters, or Bluetooth Low Energy, which has a range of around less than one meter.

The communication system information depends on the abilities, security, and type of communications technology that the core device 65 has in communicating with the device 15. In an aspect, the administrator device 10 communicates this communication information in a standard or specialized format.

In an aspect, when setting up the administrator device 10 to administer access to the core device 65, one could implement a close proximity technology such as NFC, to initiate pairing to the core device 65 using a second channel such as Wi-Fi. The NFC part could be an NFC tag on the instruction manual of the core device when you first get it, or it could be a strategically placed NFC tag or NFC communication device embedded on the back or bottom of the core device. It is presumed that during the interaction between the core device 65 and the administrator device 10, a user wants to leave the administrator device 10 on top of the core device 65 and have to go through the screens of the setup for administration when holding that administrator device 10, especially if that requires holding administrator device 10 in an uncomfortable angle to maintain communications.

In an application of the invention, if the core device is a smart TV and the NFC device, e.g., a NFC tag, to initiate second channel communications is located on the back of the TV, then this method allows a user to “touch” the back of the TV, e.g., the NFC tag, with the administrator mobile communication device, and then that causes a connection via Wi-Fi between the mobile communication device and the TV. At that point, the user no longer has to hold the administrator mobile communication device in close proximity to the NFC tag and the user can more easily go through the setup screens of the administration program running on user's phone. In an aspect, the first channel can be used as both an initiator of a second channel for communication or as both the first and second communication channel.

In FIG. 2 (b) the NFC mobile communication device 10 uses the communication system information and establishes communications with the core device 65 using the secondary communication system 24. Assuming no other device has already established and maintained administrator status, after pairing with the core device 65 through the secondary channel, the NFC mobile communication device 10 becomes the administrator device for core device 65. Mobile communication device 10 receives linking information from core device 65 for access use by a non-administrator device(s) to access the core device 65. In an aspect, the mobile communication device 10 provides management rules to the core device 65. In another aspect, the mobile communication device 10 receives management rules from the core device 65.

In FIG. 2 (c), a non-administrator mobile communications device 15, which desires wireless access to the core device 65, is placed dose to the administrator device NFC mobile communication device 10 and the two devices establish communications 26, preferably using NFC communications. The administrator device 10 provides linking information for the core device 65 to the non-administrator device 15. In an aspect, the linking information includes a password. In an additional aspect, the administrator device provides management rules for access to the core device 65. As part of the linking information, the administrator device 10 provides non-administrator device 15 with the identification of a secondary communication system in which the non-administrator device should communicate with the core device 65. FIG. 2(c) includes another non-administrator mobile communications device 17, administrator mobile communications device 10 pairs with non-administrator mobile communications device 15. In another aspect, administrator mobile communications device 10 pairs with non-administrator mobile communications device 17 before, after, or instead of administrator mobile communications device 10 pairing with non-administrator mobile communications device 15.

In FIG. 2 (d), the non-administrator device 15, using a secondary communication system 28, establishes communications with core device 65 using at least part of the linking information provided from the administrator device 10.

This secondary communication system is, for example, Bluetooth, Wi-Fi, LAN, and Internet. In an aspect, this second communication system is the same from the secondary communication system described above with respect to FIGS. 2 (a)-(b). In another aspect, this second communication system is different from the secondary communication system described above with respect to FIGS. 2 (a)-(b). In another aspect, a second distinct channel is not used; the second channel is the same as the first communication channel that the non-administrator mobile communications device 15 uses to communicate with the administrator mobile communications device 10. In certain situations, it is more convenient to use the first channel as the communication channel only, instead of using the first channel to initiate the second channel for communication.

For example, a user can have Wi-Fi credentials and management rules defined on their administrator Smartphone, and then can simply tap their friend's non-administrator phone when they visit and communicate the information to the friend's non-administrator phone using only NFC communications. In another approach, a user employs NFC communication between their administrator phone and their friend's non-administrator phone to establish a second channel such as Bluetooth with the non-administrator phone. Then the second channel is used between the administrator phone and the non-administrator phone to communicate to the friend's phone the credentials and management rules for using the user's Wi-Fi network, e.g., to give the friend's phone internet access.

Thus, an administrator device 10 has provided to a non-administrator device 15 credentials and management rules that enables the non-administrator device 15 to access core device 65.

As such, an administrator device 10 has stored information, e.g., credentials and management rules, that can be easily and securely conveyed to a third party's device 15 to easily and securely give to the third party device 15 located in close proximity to the administrator device 10. Once the credentials and management rules are received by the non-administrator device 15, the non-administrator device 15 does not have to be in close proximity to the core device 15, only within the range of the communication technology being employed for communications between the non-administrator device 15 and the core device 65. The core device 65 is, at least an earlier time, is in close proximity to the administrator device 10 to establish initial communications between the administrator device 10 and the core device 65. for accessing a core device that may or may not be nearby, but its access is administered by the manager device.

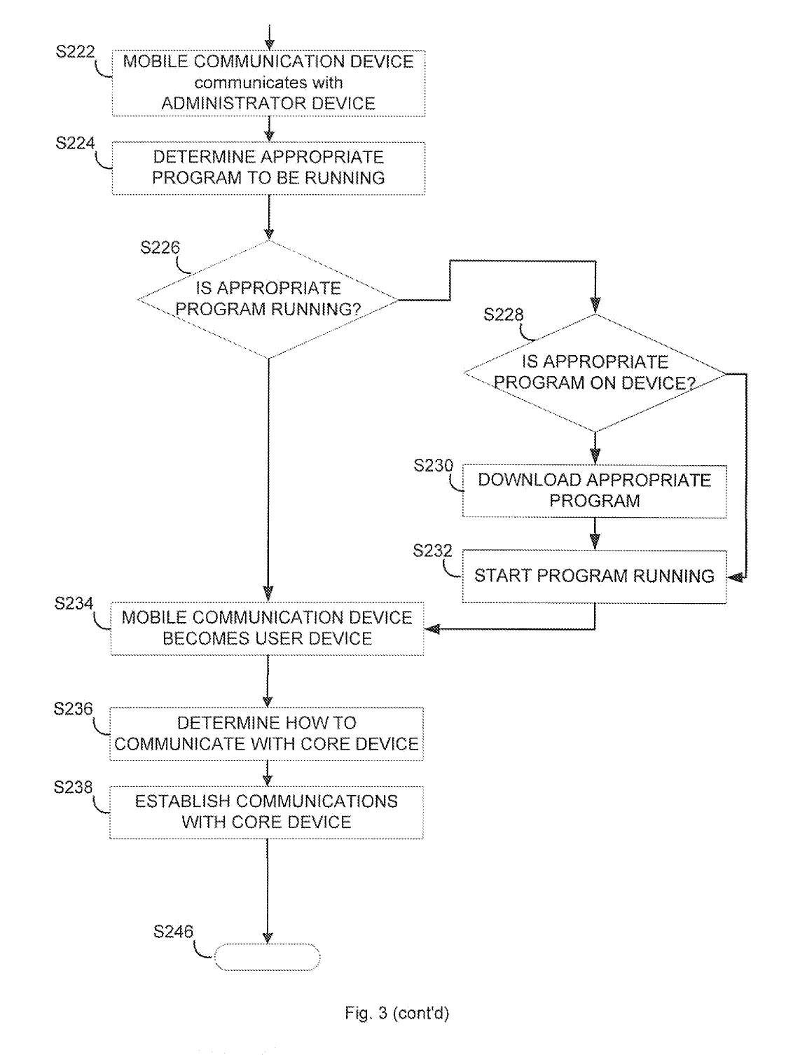

FIG. 3 is a flow chart depicting an exemplary process flow for using a mobile communication device to control access to a core device read tags in a sequential flow. This process flow is based on an exemplary application of the system described with respect to FIGS. 1 and 2(a-d).

The process starts at S200 and proceeds to segment S202.

In segment S202, the mobile communication device 10 using its standard NFC communication abilities establishes NFC communications with a core device 65 and reads a first data. Process continues to segment S204.

In segment S204, the mobile communication device 10 interprets the data from the core device 65. The mobile communication device determines the appropriate program to be running on the mobile communication device 65 for the context determined by the scenario. Process continues to segment S206.

In segment S206, the mobile communication device 10 determines if it running the appropriate program, e.g., the administrator program. If it is not running then the process continues to segment S208. Otherwise process continues to segment S214.

In segment S208, the mobile communication device 10 determines if the appropriate program resides on the mobile communication device 10. If the appropriate is not residing on the mobile communication device, then process continues to segment S210. Other process continues to segment S212.

In segment S210, the mobile communication device using conventional NFC abilities determines from the data and executes a process to make communication with an appropriate computer system and downloads the appropriate program on to the mobile communication device 10. Process continues to segment S212.

In segment S212, the mobile communication device 10 starts the appropriate program executing. Process continues to segment S214.

In segment S214, the mobile communications device 10 determines from the data received from the core device 65 how to subsequently communicate with the core device. Process continues to segment S216.

In segment S216, the mobile communications device 10 establishes communication with the core device 65 using the second communication method determined from the data. In an aspect, the mobile communications device 10 uses access information, including a password, included in the data received from the core device 65 to access the core device using the second communication method. Process continues to segment S218.

In segment S218, the mobile communication device 10 administratively pairs and links with core device 65 and becomes the administrator device for core device 65. Process continues to segment S222.

In segment S222, the mobile communication device 15 using its standard NFC communication abilities establishes NFC communications with a mobile communication device 10 and reads a second data. Process continues to segment S224.

In segment S224, the mobile communication device 15 interprets the data from the mobile communication device 10. The mobile communication device 15 determines the appropriate program to be running on the mobile communication device 15 for the context determined by the scenario. Process continues to segment S226.

In segment S226, the mobile communication device 15 determines if it running the appropriate program, e.g., the user program. If it is not running then the process continues to segment S228. Otherwise process continues to segment S234.

In segment S228, the mobile communication device 15 determines if the appropriate program resides on the mobile communication device 15. If the appropriate is not residing on the mobile communication device, then process continues to segment S230. Other process continues to segment S232.

In segment S230, the mobile communication device 15 using conventional NFC abilities determines from the data and executes a process to make communication with an appropriate computer system and downloads the appropriate program on to the mobile communication device 15. Process continues to segment S232.

In segment S232, the mobile communication device 15 starts the appropriate program executing. Process continues to segment S234.

In segment S234, the mobile communication device 15 pairs and links with mobile communication device 10 and becomes a user device for core device 65. Process continues to segment S236.

In segment S236, the mobile communications device 15 determines from the data received from the mobile communications device 10 how to communicate with the core device 65. Process continues to segment S238.

In segment S238, the mobile communications device 15 establishes communication with the core device 65 using the second communication method determined from the data received from mobile communications device 10. In an aspect, the mobile communications device 15 uses access information, including a password, included in the data received from the mobile communications device 10 to access the core device 65 using the second communication method. Process continues to segment S242.

In segment S242, the process is complete.

Thus, at the end of the process, mobile communication device 10 has provided mobile communication device 15 access to core device 65.

In another aspect of this example, administrator NFC mobile communication device 10 implements a management rule to allow mobile communication device 15 to send and receive information from/to core device 65.

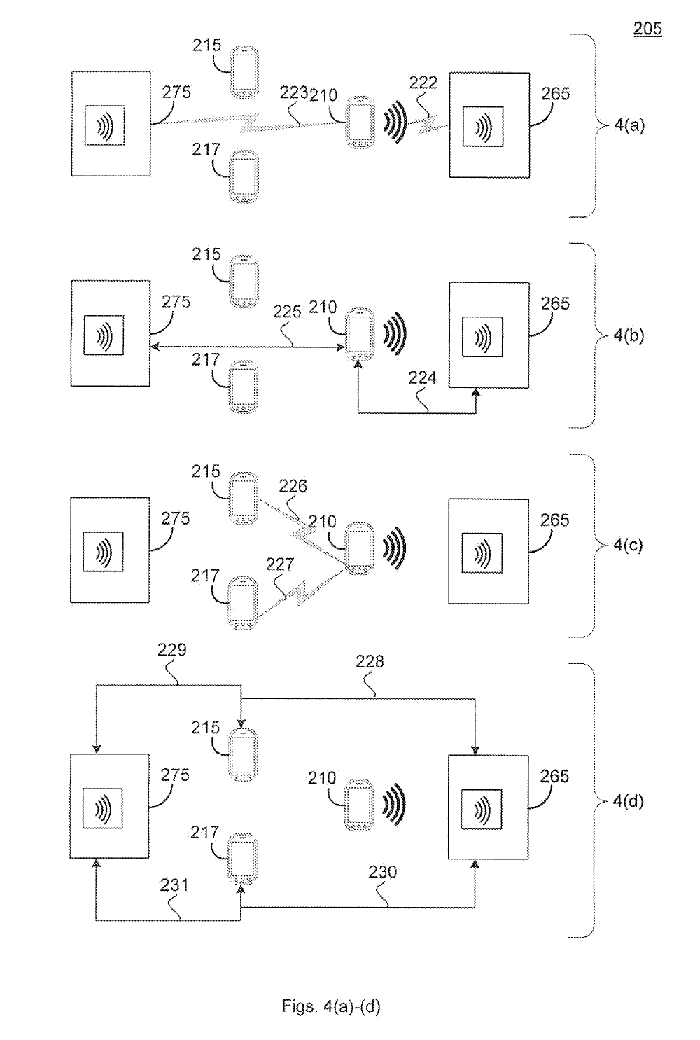

FIGS. 4 (a)-(d) depict another exemplary application of the invention where an administrator device links two non-administrator devices to two core devices. System 205 includes two core devices 265, 275, an administrator mobile communications device 210 and two non-administrator mobile communications devices 215, 217.

In FIG. 4 (a), an NFC mobile communication device 210 establishes communications 222, 223, respectively, with a first core device 265 and a second core device 275. Preferably, the communications are near field communications and receives communication system information to access the core device through a secondary communication system, e.g., Bluetooth, Wi-Fi, LAN, Internet, or otherwise.

In FIG. 4 (b) the NFC mobile communication device 210 uses the communication system information and establishes communications 224, 225, respectively, using a secondary communication system with each respective core device 265, 275. Assuming no other device has already established and maintained administrator status, after pairing with core device, the NFC mobile communication device 210 becomes the administrator device for both respective core devices 265, 275. The mobile communication device 210 may provide respective management rules to the core device 265 and/or core device 275. Mobile communication device 210 receives linking information for access use by non-administrator device(s) to access the core devices.

In FIG. 4 (c), the administrator device NFC mobile communication device 210 establishes communications 226 with a non-administrator device 215, preferably by NFC communications, which desires access to one of or both of the core devices 265, 725. The administrator device 210 provides linking information of one of or both of the core device 265, 275 to the non-administrator device 215. In an aspect, the administrator device provides management rules for access to the core devices 265, 275. The administrator device 210 also provides non-administrator device 215 with the respective identification of a secondary communication system in which the non-administrator device should communicate with one of or both of the core devices 265, 275. This secondary communication system is the same or different from the secondary communication system described above with respect to FIG. 4 (b).

The administrator device NFC mobile communication device 210 establishes communications 227 with a non-administrator device 217, preferably by NFC communications, which desires access to one of or both of the core devices 65, 75. The administrator device 210 provides linking information of one of or both of the core device 265, 275 to the non-administrator device 217. In an aspect, the administrator device provides management rules for access to the core devices 265, 75. The administrator device 210 also provides non-administrator device 217 with the respective identification of a secondary communication system in which the non-administrator device should communicate with one of or both of the core devices 265, 275. This secondary communication system is the same or different from the secondary communication system described above with respect to FIG. 4 (b).

In FIG. 4 (d), the non-administrator device 215, using the secondary communication system, establishes communications 228, 229, respectively, with one of or both of core devices 265, 275 using the password provided from the administrator device. At substantially the same or different time, the non-administrator device 217, using the secondary communication system, establishes communications 230, 231, respectively, with one of or both of core devices 265, 275 using the password provided from the administrator device.

Thus, administrator device 210 has enabled two non-administrator devices 215, 217 to be in communication with two core devices, 265, 275.

FIG. 4 shows mobile communication device 10 having linking information to Device 65 which is not NFC enabled. Mobile communication device 10 takes the stored linking information and communicates the linking information and management rules to mobile communication devices 15 and 17 via NFC. Using the linking and management rules, mobile communication devices 15 and 17 link and then communicate with Device 65 via a secondary communication method.

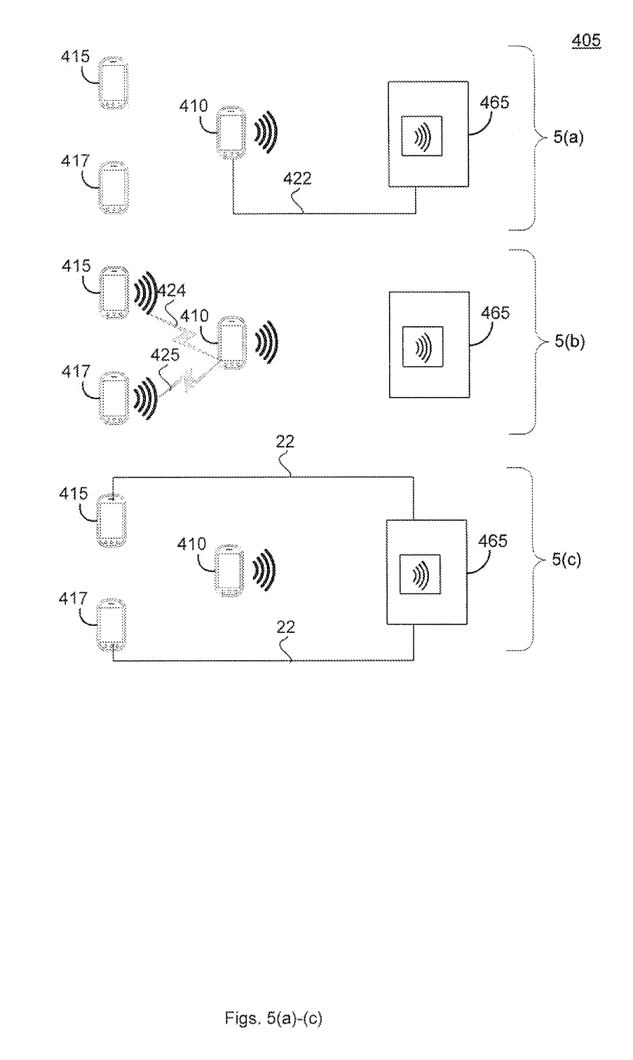

FIGS. 5 (a)-(c) depict another exemplary application of the invention where an administrator device links two non-administrator devices to a core device. System 405 includes core devices 465, an administrator mobile communications device 410 and two non-administrator mobile communications devices 415, 417.

In FIG. 4 (a) the NFC mobile communication device 410 uses stored communication system information (stored at a previous time) and establishes communications using a secondary communication system with the core device. Assuming no other device has already established and maintained administrator status, after pairing with core device, the NFC mobile communication device 410 becomes the administrator device. The mobile communication device 410 provides management rules to the core device 465. Mobile communication device 410 receives linking information for access use by non-administrator device(s) to access the core device 465.

In FIG. 4 (b), the administrator device NFC mobile communication device 410 establishes communications with non-administrator device 415, 417 preferably by NFC communications, which desires access to the core device 465. The administrator device 410 provides linking information of the core device 465 to the non-administrator devices 415, 417. In an aspect, the administrator device provides management rules to non-administrator devices 415, 417 for access to the core device 465. The administrator device 410 also provides non-administrator devices 415, 417 with the identification of a secondary communication system in which the non-administrator device should communicate with the hub device 465. This secondary communication system is the same or different from the secondary communication system described above with respect to FIG. 4 (a).

In FIG. 4 (c), the non-administrator devices 415, 417 using the secondary communication system, establishes communications with core device 465 using the password provided from the administrator device 410.

In an aspect of this example, administrator NFC mobile communication device 410 implements a management rule to only allow mobile communication device 415 to receive information from core device 465, but mobile communication device 415 cannot send information to core device 465. Management rules can run in mobile communication device 415 and/or administrator mobile communication device 410 can use NFC or a secondary communication method to communicate to core device 465 to remove or modify access for mobile communication device 415.

In this example, core device 465 streams music through the secondary communication method and at the end of 4 (c), mobile communication device 415, 417 can receive the music (e.g., data) provided by device 465.

In another aspect of FIG. 4, Administrator device 410 receives unique identification information from device 415. Device 415 is already using a common secondary communications method as device 465. Device 465 sees that device 415 is trying to communicate and gain access. Device 410, receiving the identification information of device 415, communicates that information to device 465, via NFC or other second communication system. Device 465 receives identification information for device 415. Administrator device 410 also transmits management rules for device 465 to use when communicating with device 415. Device 465 stores device 415 identification information and rules for interaction with device 415. Device 410 can remove, modify, or close communication between device 415 and device 465 at any time, using NFC and/or secondary communications system.

The invention can also use a dual or shared communication method, using NFC and a second communication in conjunction with each other. Today, not all devices have NFC capabilities. Therefore, one can NFC enable a device using an accessory or an NFC tag. If one is to use an NFC Tag, the NFC tag can contain the first step communication instructions. An example of this is a laptop which has no NFC, but does have Bluetooth. The NFC Tag can be read by an NFC Mobile device, and then use the information read from the NFC Tag, to initiate Bluetooth communication with the core device. At this stage, the core device and the NFC Phone for the administrator are now communicating through Bluetooth, but initiated communication using the information and instruction that was in the NFC Tag. With an NFC accessory, the non-NFC enabled laptop can be fully NFC enabled, by connecting the NFC accessory to give that laptop this capability. For example, plugging and NFC accessory to a USB port in the laptop can give it NFC capability.

To expand on management rules. These rules can be narrowed to specific categories of options. These can include but are not limited to time, access areas, read/write ability, control privileges, behavior rules, disruption rules, and malicious intent sensing. Time would be for example, giving your refrigerator repair man, 2 hours access to your refrigerator via the repair mans tablet. Access areas for example, could be certain folders, applications, or services running on or accessible by the core device. Read/Write ability is for example, the ability for the third device to modify, remove, or add information of the first core device. Control privileges for example, would allow the administrator to define to the third device, certain levels of administration to control the first core device. This would include things like changing the core device settings.

Behavior rules are based on monitoring the usage of the third device when interacting with the core device. These can be defined with alarms, preset rules, or dynamic monitoring. For example, the administrator stating that if the third device has used more than 2 GB of bandwidth with the first core device, the communication between first and third device is stopped. Or it can simply alarm the second device, and wait for the administrator to take action and make a decision about the third device. Or in dynamic monitoring, the administrator dynamically monitors and based on their monitoring, takes action on the third devices behavior. Disruption rules are ones that the administrator can define or monitor, which involves on how the usage of the first device by the second device, can impair or stop normal or proper operations of the first device. For example, if there are more than one third devices, if one of the third devices is eating up most of the bandwidth of communication to the core device, then that specific third device is disrupting normal communication between the core device and the other third devices. Finally, malicious intent sensing monitors if the third device, during usage of the first device, implements an action that would be considered malicious. For example, if the second device is scanning the communication between the third and core devices, and the third device sends over a file to the core device that the first device might consider a virus, then the first device can take automatic or dynamic action in access between the second device and the third device. Though certain rule options where defined, the invention should not be limited to these options.

In a usage example, the administrator has an NFC mobile communication device. They have a friend in their home, which wishes to access the internet via the administrator's Wi-Fi network. The administrator either has the linking information for the Wi-Fi router in their NFC mobile communication device, or taps their NFC mobile communication device to their NFC Wi-Fi Router. The NFC mobile communication device now has the Wi-Fi Router linking information. The NFC mobile communication device now distributes this linking information to their friends NFC Tablet. With the linking information, the NFC mobile communication device also communicates via NFC, a management rule that will restrict the Tablet from having Wi-Fi access to the administrator's home Wi-Fi network for no more than 2 hours.

In another example, the administrator has an NFC mobile communication device. They are at a party in a remote location. The administrator is streaming music held on their mobile communication device to an NFC Boom Box. Another person at the party has an NFC mobile communication device and wishes to take over as DJ. The administrator taps the NFC Boom Box and then taps the second NFC mobile communication device. This action now transfers streaming of music from the administrator's mobile communication device to the second person's mobile communication device. Now the second person has become the DJ.

In another example, the administrator is in a meeting, giving a presentation. They are using their NFC Tablet to stream and control the presentation which is streaming to a projector. During the meeting, a second business associate wishes to take over the presentation. The administrator is both streaming the presentation from their tablet as well as controlling the presentation. The administrator taps their NFC Tablet to the business associates NFC mobile communication device. The administrator continues streaming the presentation from their tablet, but has now given the business associate's NFC mobile communication device the ability to control the presentation as well.

In another example, the administrator is at home and has a friend visiting who has recently gone on a trip. The friend has photos they wish to show, which are contained in their NFC mobile communication device. The administrator decides to allow the friend to stream the photos on the administrator's home television. The home television is NFC enabled and stores authorized users who can have access to it. The administrator taps their NFC mobile communication device to the friends NFC mobile communication device, taking from the friend's mobile communication device, identifying information which can be recognized as it broadcasts its availability to allow linking to the TV. The administrator is the only NFC mobile communication device that the NFC Television allows to authorize users for accessing it. The Administrator taps their NFC mobile communication device to the NFC TV, there by transferring the friend's mobile communication device identification and giving permission to the NFC TV to allow the friend to access the TV. The friend can then begin streaming their trip photos onto the administrators TV. The administrator can later remove access permission by communicating to the TV via NFC or a secondary communication method, to remove that user from the list of authorized users stored locally in the TV.

In another example, the administrator's network connected refrigerator is not functioning properly. The administrator contacts a repair person. The refrigerator is an advanced refrigerator which can communicate to a device via wired or wireless communication. The administrator taps their NFC phone to the NFC Tablet of the repair man, thereby giving the repair man access to the refrigerator. The administrator also sends over management rules to the repair man. So the repair man does not have access to view or modify the shopping list or purchased item history that is contained in the refrigerator. The repair man is also given only two hours of access to the refrigerator.

In another example, the administrator is a parent. The have purchased a teddy bear that is network connected. The teddy bear can download stories from authorized devices that the administrator defines. The administrator taps their phone to the teddy bear, upon purchase, locking in that they are the administrator. The teddy bear stores which devices are given access to it. The administrator taps the tablet of the other parent, grabbing their unique device information. Then the administrator taps the teddy bear, communicating tot the teddy bear that it should include that specific tablet as one of the devices authorized to upload stories to the teddy bear. The teddy bear only uses NFC to NFC communication, so there is no second communication available. When the second parent or the administrator wish to upload a new story or remove an old story form the teddy bear, the must tap and communicate with the teddy bear via NFC to NFC communication.

There are many possible uses of this method. In general, the invention is designed to use one or more administrators to distribute linking information and management rules to one or more third devices, to give the third devices access to a second device which the administrator administers access to.

While the invention has been described and illustrated with reference to specific exemplary embodiments, it should be understood that many modifications, combinations, and substitutions can be made without departing from the spirit and scope of the invention. For example, an operation described as occurring in software is not necessarily limited to be implemented in software and can be partially, substantially, or completely implemented in hardware. Similarly, an operation described as occurring in hardware is not necessarily limited to be implemented in hardware and can be partially, substantially, or completely implemented in software. Accordingly, the invention is not to be considered as limited by the foregoing description but is only limited by the scope of the claims.

What is claimed as new and desired to be protected by Letters Patent of the United States is:

1. A method of electronically connecting a first and third devices using a second device, comprising:
communicating using a first communication method by said second device with the first device;
receiving using said first communication method by said second device from said first device a first linking information for said first device;
communicating using a second communication method by said second device with the first device;
receiving using said second communication method by said second device from said first device a second linking information for said first device;
communicating using a third communication method by said second device with the third device;
providing to said third device using said third communication method by said second device said second linking information for said first device;
communicating using a fourth communication method by third device with the first device; and
providing to said first device using said fourth communication method by said third device linking information provided by second device to third device, thereby giving third device communication access to first device.

2. The method of claim 1, where said first communication method is the same as said third communication method.

3. The method of claim 2, where said first communication method is different from said second communication method.

4. The method of claim 3, where said third communication method is different from said fourth communication method.

5. The method of claim 1, wherein said linking information received from first device to second device includes information for accessing said first device.

6. The method of claim 1, wherein said linking information received from first device to second device includes information regarding capabilities of said first device.

7. The method of claim 6, wherein said linking information received from second device to third device includes information regarding capabilities of said first device.

8. The method of claim 1, where second devices communicating to third device, information received by first device, as to the capabilities of first device that third device can access when communicating with first device.

9. The method of claim 1, further comprising the steps of:
said second device defining a rule for said third device when communicating to first device; and
said second device communication said rule to said third device.

10. The method of claim 9, wherein said rule includes a time period when said third device can communicate with first device.

11. The method of claim 9, wherein said rule includes a restriction on a function of said first device.

12. The method of claim 1, wherein said first communication method is a close proximity communication method, and
wherein said third communication method is a close proximity communication method.

13. The method of claim 1, wherein said first communication method is a near field communication method, and
wherein said third communication method is a near field communication method.

14. A method of enabling wirelessly communications between a first and third device using a second device, comprising:
downloading and executing an administrator program onto a first mobile communication device;
downloading and executing a use program onto a second mobile communication device;
wirelessly communicating using a first communication method by said first mobile device with a third electronic device;
receiving using said first communication method by said first device from said third electronic device linking information for said third device device;
wirelessly communicating using a second communication method by said first mobile communication device with said second mobile communication device; and
providing by said first mobile communication device to said second communication device said linking information for said third device.

15. The method of claim 14, wherein said first communication method is near field communications.

16. The method of claim 14, wherein said first communication method is near field communications.

17. The method of claim 14, further comprising the steps of:
creating on said first mobile communication device a management rule regarding what communication method by which said second mobile communication can communicate with said third device; and
providing by said first mobile communication device to said second mobile communication device said management rule.

18. The method of claim 17, wherein said communication method in said management rule is Wi-Fi communications.

19. The method of claim 14, further comprising the steps of:
creating on said first mobile communication device a management rule regarding what time period by which said second mobile communication can communicate with said third device; and
providing by said first mobile communication device to said second mobile communication device said management rule.

20. The method of claim 19, further comprising the step of:
disabling at a time outside said time period by said second mobile communication device communications with said third device.
